(19) United States
(12) Patent Application Publication
(10) Pub. No.: US 2011/0264524 A1
(43) Pub. Date: Oct. 27, 2011

(54) Method and System for Implementing and Using a Delivery Point Uniform Locator

(76) Inventors: Joseph Henry Ewers, Grand Prairie, TX (US); Ronald Norbert Ewers, Grand Prairie, TX (US); Kenneth Wayne Murphy, Dallas, TX (US); Arthur R. Bunten, Irving, TX (US)

(21) Appl. No.: 13/082,318

(22) Filed: Apr. 7, 2011

Related U.S. Application Data
(60) Provisional application No. 61/342,043, filed on Apr. 8, 2010.

(51) Int. Cl. G06Q 30/00

(52) U.S. Cl. 705/14.53; 705/14.66

(57) ABSTRACT

The present invention is a system and method for implementing and using a delivery point identification number (ID) that provides a unique ID for each household in a region or country. The invention includes a process of loading a National Resident Database indexed with the unique delivery point ID that allows each household in a region or country to be quickly and accurately identified, and persons at the household can use the delivery point ID when accessing a website, webpage or other Internet access point to allow access webpages, direct promotional pop-up adds to the household, direct coupons or redeemable discount offers to the household, record purchase preferences in a household record, send traffic based on those preferences. This process is called Delivery Point Uniform Resource Locator, or DP-URL.

### RELATED APPLICATION DATA

This application is related to Provisional Patent Application Ser. No. 61/342,043 filed on Apr. 8, 2010, and priority is claimed for this earlier filing under 35 U.S.C. §119(e). The Provisional Patent Application is also incorporated by reference into this patent application.

### TECHNICAL FIELD OF THE INVENTION

This invention relates to an improved method and system for direct delivery of marketing, promotion or other types of packaging to interested consumers using a highly efficient Delivery Point ID that is a unique ID for each household in a region or country.

### BACKGROUND OF THE INVENTION

The present invention is based in part on the Internet technology of webpages, websites, and website addresses. Present-day Internet communications represent the synthesis of technical developments begun in the 1960s—the development of a system to support communications between different United States military computer networks, and the subsequent development of a system to support the communication between research computer networks at United States universities. These technological developments would subsequently revolutionize the world of computing.

The Internet, like so many other high tech developments, grew from research originally performed by the United States Department of Defense. In the 1960s, Defense Department officials began to notice that the military was accumulating a large collection of computers—some of which were connected to large open computer networks and others that were connected to smaller closed computer networks. A network is a collection of computers or computer-like devices communicating across a common transmission medium. Computers on the Defense Department's open computer networks, however, could not communicate with the other military computers on the closed systems.

Defense Department officials requested that a system be built to permit communication between these different computer networks. The Defense Department recognized, however, that a single centralized system would be vulnerable to missile attacks or sabotage. Accordingly, the Defense Department mandated that the system to be used for communication between these military computer networks be decentralized and that no critical services be concentrated in a few, vulnerable failure points. In order to achieve these goals, the Defense Department established a decentralized standard protocol for communication between network computers.

A few years later, the National Science Foundation wanted to connect network computers at various research institutions across the country. The NSF adopted the Defense Department's protocol for communication, and this combination of research computer networks would eventually evolve into the Internet.

### Internet Protocols

The Defense Department's communication protocol governing data transmission between computers on different networks was called the Internet Protocol (IP) standard. The IP standard now supports communications between computers and networks on the Internet. The IP standard identifies the types of services to be provided to users, and specifies the mechanisms needed to support these services. The IP standard also describes the upper and lower system interfaces, defines the services to be provided on these interfaces, and outlines the execution environment for services needed in the system.

A transmission protocol, called the Transmission Control Protocol (TCP), was also developed to provide connection-oriented, end-to-end data transmission between packet-switched computer networks. The combination of TCP with IP (TCP/IP) forms a system or suite of protocols for data transfer and communication between computers on the Internet. The TCP/IP standard has become mandatory for use in all packet switching networks that connect or have the potential for utilizing connectivity across network or sub-network boundaries.

In a typical communications scenario, data is transmitted from an applications program in a first computer, through the first computer's network hardware, and across the transmission medium to the intended destination on the Internet. After receipt at a destination computer network, the data is transmitted through the destination network to a second computer. The second computer then interprets the communication using the identical protocols on a similar application program. Because of the standard protocols used in Internet communications, the TCP/IP protocol on the second computer should decode the transmitted information into the original data transmitted by the first computer.

To fully support Internet communications, the TCP/IP protocol system must perform the following tasks: (1) dividing messages into manageable chunks of data to pass efficiently through the transmission medium, (2) interfacing the network adapter hardware, (3) addressing target data to a specified computer and allowing the computer to acknowledge receipt of the data or recognize the absence of a message it was supposed to have received, and (4) routing data to a destination computer even if the source and destination computers are on different physical networks. The TCP/IP network protocol must also error check and control data flow, and TCP/IP protocol supports many important features such as logical addressing, high-level naming service, and application program support.

One of the rules in TCP/IP communications is that a computer user does not need to get involved with details of data communication. In order to accomplish this goal, the TCP/IP standard imposes a layered communications system structure. All the layers are located on each computer in the network, and each module or layer is a separate component that theoretically functions independent of the other layers.

TCP/IP and its related protocols form a standardized system for defining how data should be processed, transmitted and received on the Internet. TCP/IP defines the network communication process, and more importantly, defines how a unit of data should look and what information the message should contain so that the receiving computer can interpret the message correctly. Because the standardized layer design of TCP/IP, a consistent conversion of base data is ensured regardless of the version or vendor of the TCP/IP conversion software.

The TCP/IP protocol suite is the interface between the application programs on the computer and the data communication hardware. Each layer is responsible for a separate task or routine in the network communication. The Protocol Layers for the Basic Networking Scheme (TCP/UDP and IP) and the OSI Protocol Layers are identified in Table I.

TABLE I

| | Protocol Layers for | |
|---|---|---|
| Protocol | Basic Networking | Protocol Layer |
| Layer | Scheme | (OSI) |
| 7 | Network | Application |
| 6 | Applications | Presentation |
| 5 | | Session |
| 4 | TCP/UDP | Transport |
| 3 | IP | Network |
| 2 | Data Link | Data Link |
| 1 | Physical | Physical |

When a first computer transmits a data message to a second computer on the Internet—either sending a message or requesting information—the TCP/IP Protocol Layers in the first computer prepare the base data for transmission to a second computer by adding additional information to the base data. New pieces of information (e.g. headers) are added to the base data as the base data descends through each layer in the protocol. After processing, the base data with various headers will form a fully structured datagram under the TCP/IP protocol.

After the base data has been processed by all the layers in the protocol, it is ready for transmission across the Internet to the second computer. The datagram is transmitted on the Internet and should be received by the intended destination computer. For the second computer to interpret the incoming data, the same set of TCP/IP protocol layers are used by the second computer—only in reverse order. As the transmitted information ascends through the protocol layers in the second computer, each protocol level strips away the added information (e.g. headers) to leave the base data in the applications program of the second computer.

In the OSI model, the Application Layer (level 7) supports the transfer of information that is specific to the computer program being run by a user. Some application-layer protocols define how electronic mail is to be exchanged, while other Application Layer protocols define how files are to be transferred from one computer to another or how World Wide Web pages are to be fetched by a server from a browser page.

The Presentation Layer (level 6) in the OSI model defines the syntax and semantics of the information being exchanged by an applications program. This means that the presentation-layer protocol defines how the integers, text messages, and other data of an application program are to be encoded and transmitted over the network. This layer supports computers using different types of hardware and operating systems thereby allowing all computers to exchange information with lower protocol layers regardless of their particular method of storing or processing data.

The Session Layer (level 5) delivers a stream of data to the Transport Layer based upon the application-oriented tasks being performed in the higher level layers. Some Session Layer protocols provide periodic checkpoints allowing resumption of a communication in the event of a catastrophic network failure. In real world environments, the Application, Presentation, and Session Layers (Levels 5, 6 and 7) may be viewed as a single layer called the Application Layer.

The Transport Layer (level 4) is responsible for preparing the data for packet transmission on the Network Layer. The Transport Layer protocol defines the methods for detecting errors in a transmission of segments and for correcting these errors. The Transport Layer often uses the TCP protocol because it has a high degree of reliability and error checking capabilities. The Transport Layer could also use the UDP protocol, which is a simple interface to the Network Layer. While quicker than the TCP protocol, the UDP does not necessarily provide for increased reliability in data transmission.

In the OSI model, the Network Layer provides the interface between the physical network defined by Layers 1 and 2 (the Data Link Layer and the Physical Layer) and the higher level protocol levels defined by Layers 4-7 (the Transport, Session, Presentation and Application Layers). The Network Layer uses the frame transmission facility provided by the Data Link Layer to move data packets from their original source to their ultimate destination on the Internet.

The Network Layer supports the key TCP/IP protocols for logical addressing and routing of data. According to the IP protocol, the Network Layer formats data and addresses the data for transmission to the destination network or sub-network based on physical hardware addresses. The Network Layer protocol also defines how network devices discover the existence of other network devices and computers, and how packets find their final destination. The Network Layer also provides error checking for data delivered on the physical network.

The Data Link Layer (Level 2) provides an interface with the network adapter and maintains logical links for the network. The Data Link Layer also uses the raw bit transmission facility provided by the Physical Layer to move frames of data from one computer to neighboring computers on the same network or sub-network. The Data Link Layer protocol defines methods for ensuring the reliability of each data frame and also arbitrates access to those media types that are shared by many computers.

The Physical Layer (Level 1) moves raw data bits across a communication medium. A Physical Layer defines the electrical and mechanical characteristics of the communication media, the bit rate, the voltages, and any other parameter necessary for communication of raw data bits on the communication system. The Physical Layer converts the data stream comprising electric or analog signals and oversees the transmission of data thereon.

Tasks performed in protocol layers 2 and 3 play an important role in interfacing the high-level application program levels with the physical communications network levels. By design, the tasks performed on these lower level protocols are automated because they operate on low-level data structures and these low-level tasks control the physical hardware on the communications system. These lower level layers operate virtually by themselves with no direct user interaction or control—primarily so as to not trouble the computer user with the details of data bit transfer or routing path determinations.

### TCP/IP Protocols

A computer operating on a network is assigned a unique physical address. On a Local Area Network (“LAN”), the physical address of the computer is a number given to computer's network adapter card. Hardware LAN protocols use this physical address to deliver packets of data to computers on the LAN.

On the Internet, the TCP/IP protocol routes data packets using logical addressing. Logical addresses are generated by the network software in the Network Layer. Specifically, a logical address in the TCP/IP network is translated into a corresponding physical address using the ARP (Address Resolution Protocol) and RARP (Reverse Address Resolution Protocol) protocols in the Network Layer.

The TCP/IP's logical address is also called an IP address. The IP address can include: (1) a network ID number identifying a network, (2) a sub-network ID number identifying a sub-network on the network, and, (3) a host ID number identifying a particular computer on the sub-network. The IP addressing scheme imposes a sensible addressing scheme that reflects the internal organization of the network or sub-network.

A computer network is often subdivided into smaller sub-networks. The computer network is divided in this manner to increase data transmission efficiency and reduce overall network traffic. Routers are used to regulate the flow of data into and out of designated sub-networks of the computer network.

A router interprets the logical address information of a data packet, such as an IP address, and directs the data packet across the network to its intended destination. Data addressed between computers on the sub-network does not pass through the router to the greater network, and therefore does not clutter the transmission lines of the greater network. If data is addressed to a computer outside the sub-network, however, the router forwards the data onto the larger network.

The TCP/IP network includes protocols that define how routers will determine the path for data through the network. Routing decisions are based upon information in the IP packet header and entries in each router's routing table. A routing table possesses sufficient information for a router to make a determination on whether to accept the communicated information on behalf of a destination computer, or pass the information onto another router in the network. The routing table also permits the router to determine where the information should be forwarded within the network or sub-network.

The routing table can be configured manually with routing table entries or a dynamic routing protocol that can accommodate changing network topologies—network architecture or network layouts, routers, and interconnections between hosts and routers. In a dynamic routing protocol, a router advertises reachability when it sends updated routing information to a second router claiming that the first router is capable of reaching one or more destination addresses. Advertising accessibility is important to the process of receiving, directing and re-directing data packets on the Internet.

### SUMMARY OF THE INVENTION

The present invention is a system and method for implementing and using a delivery point identification number (ID) that provides a unique ID for each household in a region or country. The invention includes a process of loading a National Resident Database indexed with the unique delivery point ID that allows each household in a region or country to be quickly and accurately identified, and persons at the household can use the delivery point ID when accessing a website, webpage or other Internet access point to allow access webpages, direct promotional pop-up adds to the household, direct coupons or redeemable discount offers to the household, record purchase preferences in a household record, send traffic based on those preferences. This process is called Delivery Point Unifoun Resource Locator, or DP-URL. The delivery point ID can be created through a CASS certification process, and the National Resident Database can include Valassis or Compact Information.

By using this invention, the invention delivers a product for a promotion, marketing or other service provider to the household or user resulting in several key benefits such as an increase relevance/value of the mailing, improved current advertisers return on investment, additional revenue streams (with no additional investment in capital expenditures) through a Pay per Click approach, increased accumulation of household information to create competitive advantage for a promotion, marketing or other service provider, expansion of current capabilities of tracking customer preferences, utilization of strength of current postal investment to create potential proprietary product, all with a high reward—low risk investment.

### BRIEF DESCRIPTION OF THE DRAWINGS

Embodiments of the present application will now be described, by way of example only, with reference to the accompanying drawing figures, wherein:

FIGS. 1-3 are system components that support the use and implementation of the invention, and

FIG. 4 shows the Network Topology for the present invention,

FIGS. 5-9 shows Workflow Processes for the present invention,

FIGS. 10-22 show components, applications and webpages used in the present invention.

### DETAILED DESCRIPTION OF THE PREFERRED EMBODIMENTS

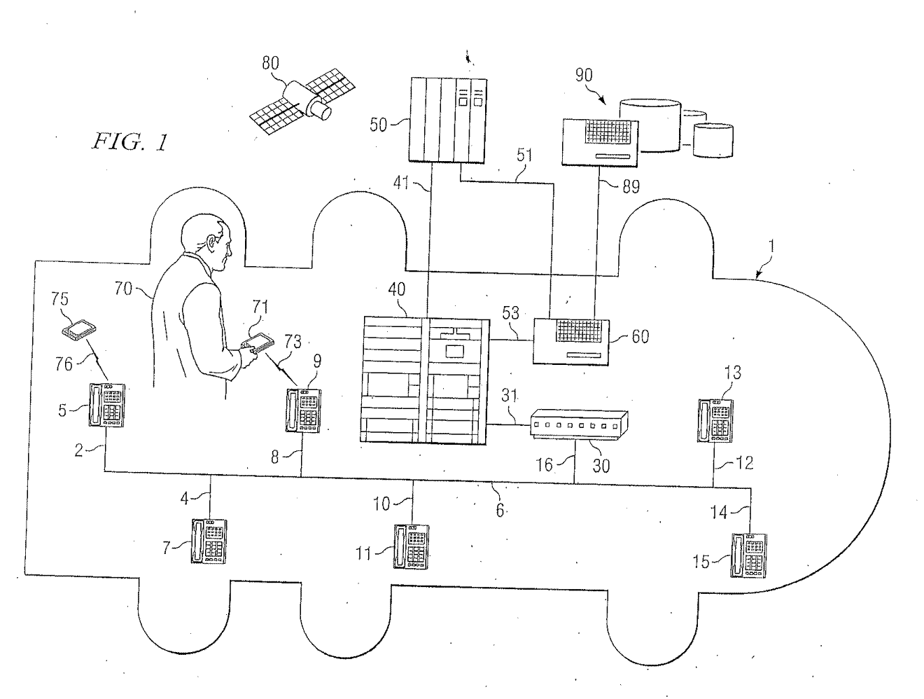

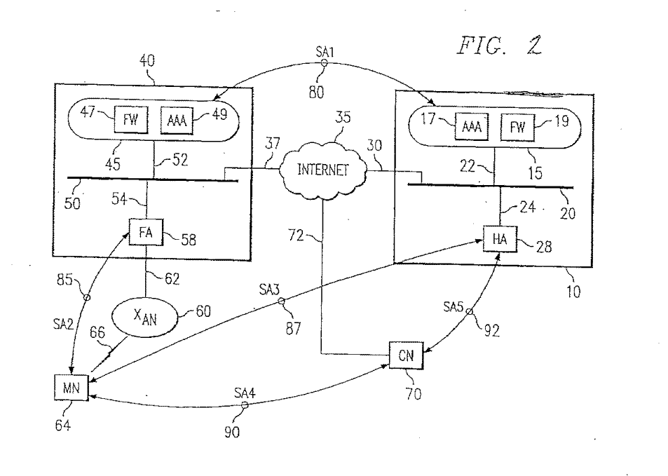

FIGS. 1 to 3 show system components that support the use and implementation of the invention. FIG. 1 shows the basic configuration and elements of the invention. The figure depicts a terminal area 1 with six types of access points coupled to an access router 30. Access point 5 is connected to a central buss line 6 by communication link 2. Access point 7 is connected to the central buss line 6 by communication link 4. Access point 9 is connected to the central buss line 6 by communication link 8. Access point 11 is connected to the central buss line 6 by communication link 10. Access point 13 is connected to the central buss line 6 by communication link 12. Access point (TAP) 15 is connected to the central buss line 6 by communication link 14. A mobile station (MS) 75 is coupled to access point 5 by wireless communication link 76. Each access point can be a phone, mobile node or computer terminal.

The central buss line 6 is connected to an access router 30 by communication link 16. The access router 30 routes information packets to and from the six access points 5, 7, 9, 11, 13, and 15. The access router 30 is linked to a Wireless Local Area Network Support Node (WLSN) 40 by communication link 31. The WLSN 40 connects to a home network home location register (HLR) 50 using communication link 41. The HLR 50 connects to a Location Center 60 using communication link 51. The Location Center 60 connects to the WLSN 40 using communication link 53, and the Location Center 60 connects to an application program 90 on a computer over communication link 89.

All the access points can transmit and receive information onto the area network 1, such as through the communication link 8 and buss line 6 to router 30, and over communication link 31. The database information is stored in the database 40 having an entry table and other database data structures for the delivery point address information, website information, or webpage information. Although the database register is stored on the database 40 in the preferred embodiment, alternatively the database can be stored in memory in another network support component such as the component 60.

Information packets are routed through the access router 30 and over the communication link 16, buss line 6, and communication link 2 to the access point 5 for transmission over the wireless link 76 to the MS 75. The routing process to the access point 5 uses the network identifier of access point 5, which will usually be the MAC address for the access point 5 on the network 1. The network 1 is the physical architecture that supports the use and implementation of the system described herein.

Although a separate access point, access router, and database are depicted in the preferred embodiment, alternate embodiments may combine these components. The access router and access point can be combined, or the access router and the database can be combined onto a single device or component. The access router, access point, and database can also all be combined into a single component.

In FIG. 2, another access system is shown with the overall architecture of the IP-based mobile system having a Mobile Node 64, a home network 10 and a foreign network 40. The home network 10 has a central buss line 20 coupled to the Home Agent 28 via communication link 24, and the buss line 20 is coupled to the AAA server 17 via communication link 22. The home network 10 is coupled to the public Internet 35 via communication link 30. A communications link is any connection between two or more nodes on a network or users on networks or administrative domains.

The foreign network 40 has a central buss line 50 coupled to the foreign agent 58 via communication link 54, and the buss line 50 is coupled to the AAA foreign network server 47 via communication link 52. The foreign network 40 is coupled to the public Internet 35 via communication link 37.

Mobile Node 64 is shown electronically coupled to the foreign network 40 via the wireless communication link 66 of transceiver 60. Transceiver 60 is coupled to the foreign network 40 via communication link 62. The Mobile Node 64 can communicate with any transceiver or Access Network coupled to the foreign network 40.

The terms Home Agent and Foreign Agent may be defined in the Mobile IP Protocol (RFC 2002), but these agents are not restricted to a single protocol or system. In fact, the term Home Agent, as used in this application, can refer to a Home Mobility Manager, Home Location Register, Home Serving Entity, or any other agent at a home network having the responsibility to manage mobility-related functionality for a Mobile Node on a home network. Likewise, the term Foreign Agent, as used in this application, can refer to a Serving Mobility Manager, Visited Location Register, Visiting Serving Entity, or any other agent on a foreign network having the responsibility to manage mobility-related functionality for a Mobile Node on a foreign network.

In the mobile IP communications system, the Mobile Node 64 may be identified by a permanent IP address. While the Mobile Node 64 is coupled to its home network 10, the Mobile Node 64 functions as any other fixed node on that network. When the Mobile Node 64 moves from its home network 10 to a foreign network 40, however, the home network 10 sends data communications to the Mobile Node 64 by “tunneling” the communications to the foreign network 40 where the Mobile Node 64 is located.

The Mobile Node 64 keeps the Home Agent 28 informed of its current location by registering a care-of address with the Home Agent 28. Essentially, the care-of address represents the current foreign network 40 where the Mobile Node is located. If the Home Agent 28 receives an information packet addressed to the Mobile Node 64 while the Mobile Node 64 is located on a foreign network 40, the Home Agent 28 will “tunnel” the information packet to the Mobile Node's 64 current location on the foreign network 40 via the applicable care-of address.

If the Mobile Node 64 is located on its home network 10, no additional action needs to be taken because information packets will be routed to the Mobile Node 64 according to the standard addressing and routing scheme. If the Mobile Node 64 is visiting a foreign network 40, however, the Mobile Node 64 obtains appropriate information from the agent advertisement, and transmits a registration request message to its Home Agent 28. The registration request message will include a care-of address for the Mobile Node 64.

The registered care-of address identifies the foreign network 40 where the Mobile Node 64 is located, and the Home Agent 28 uses this registered care-of address to tunnel information packets to the foreign network 40 for subsequent transfer to the Mobile Node 64. A registration reply message may be sent to the Mobile Node 64 by the Home Agent 28 to confirm that the registration process has been successfully completed.

A care-of address identifies the foreign network 40 where the Mobile Node 64 is located. Mobile IP protocols require that the mobile node register the care-of address with the Home Agent 28 and/or the AAA server 17 on the home network 10 after movement to a new network. As part of the registration process, a registration request is issued by the Mobile Node 64 in response to power-up on the foreign network 40 or receipt of an agent advertisement. The registration request is sent to the Home Agent 28 and/or the AAA server 17 on the home network, and a registration reply is issued by the Home Agent 28 to the Mobile Node 64 to confirm registration of the care-of address with the Home Agent 28. The registration is transmitted from Mobile Node 64 or the Foreign Agent 58 to the Home Agent 28 via Internet 35. The AAA server 17 also allows the Mobile Node 64 to access the home network 10.

In the system shown in FIG. 2, the Mobile Node 64 would have a care-of address of the foreign network 40, and the Mobile Node 64 would have registered its care-of address with the Home Agent 28. When an information packet is sent to the Mobile Node 64, these information packets would be sent to the Home Agent 28 as the agent advertising accessibility to the Mobile Node 64 on the networks. The access network in FIG. 2 is part of the network architecture that supports the use and implementation of the system described herein.

The Home Agent 28 would transfer, or tunnel, the information packets to the Foreign Agent 58 at the care-of address for the Mobile Node 64. The Foreign Agent 58 would, in turn, transfer the information packets to the Mobile Node 64 through the transceiver 60. In this manner, the information packets addressed to the Mobile Node 64 at its usual address on the home network 10 are re-directed to the Mobile Node 64 on the foreign network 40.

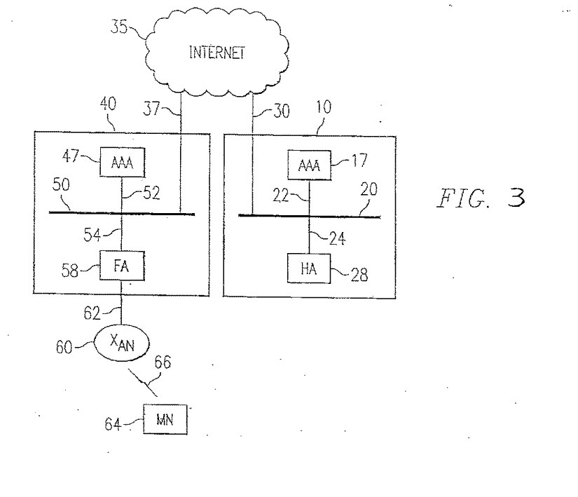

Looking at FIG. 3, the overall architecture of another IP-based mobile system is shown with Mobile Node 64, home network 10 and foreign network 40. The home network 10 has a central buss line 20 coupled to the home agent 28 via communication link 24, and the buss line 20 is coupled to the secure messaging gateway 15 via communication link 22. The secure messaging gateway 15 includes the AAA server 17 and firewall 19 for the home network. The home network 10 is coupled to the public Internet 35 via communication link 30. A communications link is any connection between two or more nodes on a network or users on networks or administrative domains.

The foreign network 40 has a central buss line 50 coupled to the foreign agent 58 via communication link 54, and the buss line 50 is coupled to the secure messaging gateway 45 via communication link 52. The secure messaging gateway 45 includes the AAA server 49 and firewall 47 for the foreign network. The foreign network 40 is coupled to the public Internet 35 via communication link 37.

A Mobile Node 64 is shown electronically coupled to the foreign network 40 via the communication link 66 of transceiver 60. Transceiver 60 is coupled to the foreign network via communication link 62. The Mobile Node 64 can communicate with any transceiver or Access Network coupled to the foreign network 40. The system also includes a correspondent node CN 70, which is a node wishing to communicate with the Mobile Node 64. The correspondent node CN 70 is coupled to the public Internet 35 via communication link 72.

The present invention includes the capability of forming five different SAs securely connecting various nodes and routers on the Internet. The following security associations will connect the following nodes and routers:

(1) SA1—the SA1 80 securely connects the secure messaging gateway 15 in the home network 10 to the secure messaging gateway 45 in the foreign network 40,

(2) SA2—the SA2 85 securely connects the Mobile Node 64 to the Foreign Agent 58 in the foreign network 40,

(3) SA3—the SA3 87 securely connects the Mobile Node 64 to the Home Agent 28 in the home network 10,

(4) SA4—the SA4 90 securely connects the Mobile Node 64 to the correspondent node 70, and

(5) SA5—the SA5 92 securely connects the correspondent node 70 to the Home Agent 28 in the home network.

The security scheme in the present invention covers one or more portions of the public network as mandated by the needs of the user and the level of security desired. At the very least, SA1 80 is needed to traverse the public networks in the Internet. If SA1 80 and SA2 85 (or an equivalent) are available and the foreign network 40 can be trusted, SA3 would be optional because it would cover redundant relationships already covered by SA1 and SA2. Further, SA4 is only needed if the policies at the Mobile Node 64 require its use. If SA1 80 is not available, the system should secure transmission of information packets by using SA3 87 and SA4 90 between the Mobile Node 64 and the Home Agent 28 or correspondent node 70, respectively.

SA2 connection may be unnecessary if the Mobile Node 64 communicates with the Foreign Agent 58 using a code-based communication scheme, such as a CDMA-based communication scheme. Further, the security of the system could be enhanced by SA5 92 between the correspondent node 70 and the Home Agent 28 if the correspondent node 70 is not associated with the home network. The network shown in FIG. 3 is the network access architecture that supports the use and implementation of the system described herein.

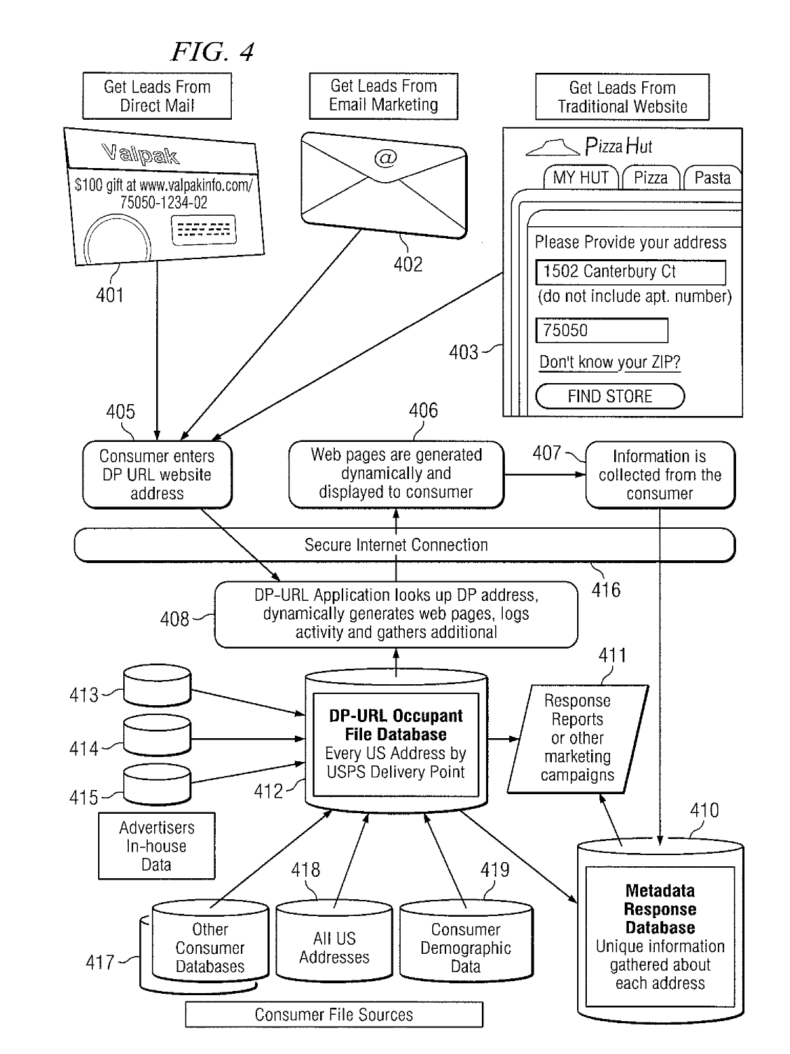

FIG. 4 shows the system components and network topology for the present invention. The consumer may receive a direct mailing 401 that possesses a delivery point user uniform resource locator DP-URL designation that is unique to the recipients' address location, such as “www.valpakinfo.com/75050-1234-02” or “www.customerurl.com/75050-1234-02.” T part of this DP-URL code identifier is the uniform resource locator URL number, and the second part of the DP-URL code after the “/” mark is the delivery point identifier that is unique to a particular household or location in a region or country. The DP-URL code may be generated based on database information for a particular user or recipient, such as the recipient's zip code and address. This address and zip code information, as well as name and other information, may be entered by the user or recipient on the webpage 403 or may be generated from mailing lists or other database information. From this type of information, the DP-URL code can be generated.

The DP-URL code can also be entered as a quick link to an email solicitation directed to the user or recipient as shown in 402, or a user or recipient may enter the DP-URL code into a webpage 403. When the user or recipient enters the DP-URL code as an Internet designation, a DP-URL applications program is accessed in step 408, where the applications program looks up the DP delivery point designator address, dynamically generates webpages based on the delivery point DP designation at step 408, logs activities of the user or recipient associated with that unique delivery point DP designation, and gathers additional information from the user or recipient associated with that unique delivery DP designation at step 407. The access of the user or recipient to the DP-URL applications program may be done through a secure Internet connection, shown at 416, and the interactions with the webpages in steps 408, 407 and 406 can also be performed through a secure Internet connection shown at 416.

In response to the initiation of the DP-URL applications program in step 408 and the activities performed at steps 406 and 407, data is transferred and stored at a DP-URL Response database 410. This DP-URL Response database stores responsive data collected from users and recipients, including unique information gathered regarding the unique address associated with the unique DP-URL code identifier. This information may be exported in a paper or electronic format to advertisers, marketers or promoters, as well as product producers. The uses for this information include telemarketing, personal sales visits, direct mailing, and email marketing.

This database information provides the advertiser or promoter with flexibility to determine the types of products that appeal to a particular household user or recipient, or the types of branding initiatives to take in order to most effectively promote a product or service (e.g. telemarketing, email, direct mail, or personal visit). Email marketing 402 can include personalized emails using demographic information secured from the DP-URL Response database 410, and direct mailing 401 can include postcards, self-mailers, letter based information that may drive responses from the user or recipient. These emails and direct mailings may drive additional responses and information to be provided to the DP-URL Response database 410.

The DP-URL Response database 410 may export information to Response Reports 411 to provide product producers with information on the advertising campaign and consumer feed-back. The DP-URL Occupant database 412 is a loaded database of addresses for a particular region or country, which can include a pre-loaded database provided through the postal service, Valassis, Compact Information Services, or NAAD. This information would contain address information and head of household names. The information in the DP-URL Occupant database 412 may be supplemented by information retrieved from advertiser in-house databases 413, 414, and 415 (e.g. demographic information, acquired through “landing pages,” or transaction based data), other consumer databases such as US address database 418 (e.g. provided through Experian, Acxiom, InfoUSA, Equifax, Knowledgebase), consumer demographic information database 419 (e.g. mailing address, income, home value, age of house, or 200+ other demographic categories), or other consumer databases 417 such as an email consumer file that connects email addresses with mailable address locations or all emails associated with the physical address location.

As shown in FIG. 10, a mailing having a DP-URL code for a particular unique address may be used to provide information to the DP-URL Response database 1002. This information provided to the DP-URL Response database 1002 may include occupant data, consumer data and advertiser data. Other ways to access the DP-URL Response database 1002 and provide information to that database include call centers, point of sale terminals, and website access. This data is then used to produce specific reports to advertisers or product producers 1003, prepare specific types of marketing materials through particular types of marketing channels 1004 (e.g. emails, letters, postcards), and prepare personalized “landing pages” 1005 that provide the user or recipient with particular banner or side page advertisements based on the particular preferences recorded about the user or recipient on the DP-URL Response database 1002. Particular types of products or specific redeemable offers may be placed on the landing page 1005 for a particular household, user or recipient based on personalized preferences recorded in the DP-URL Response database 1002 for that household, user or recipient associated with that DP-URL code.

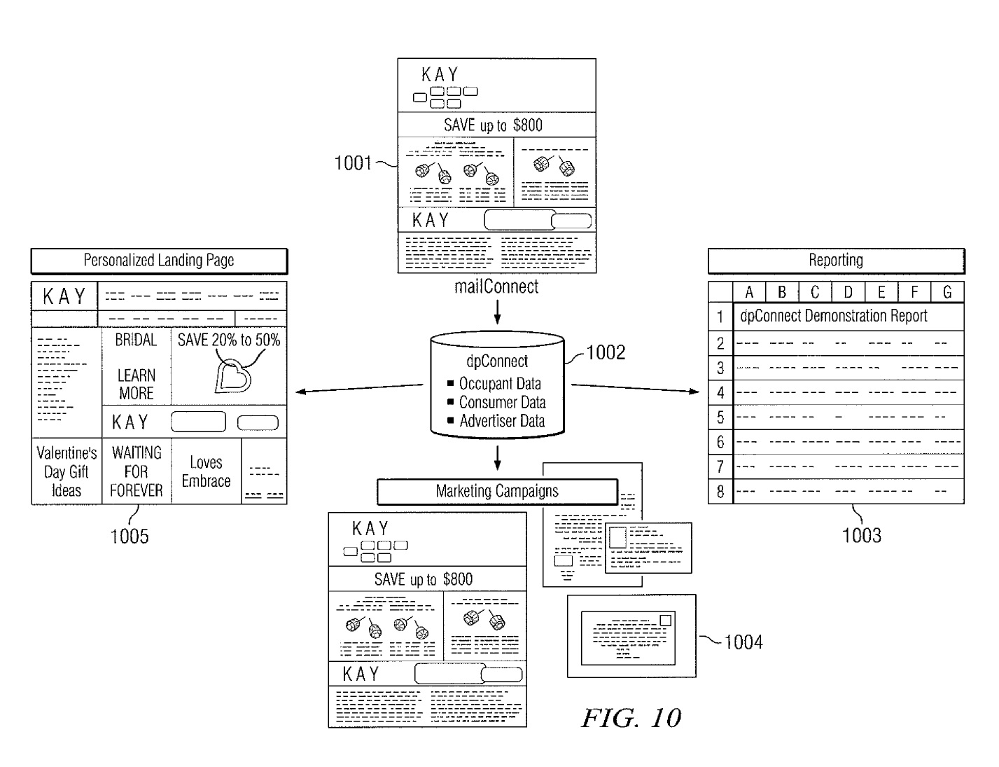

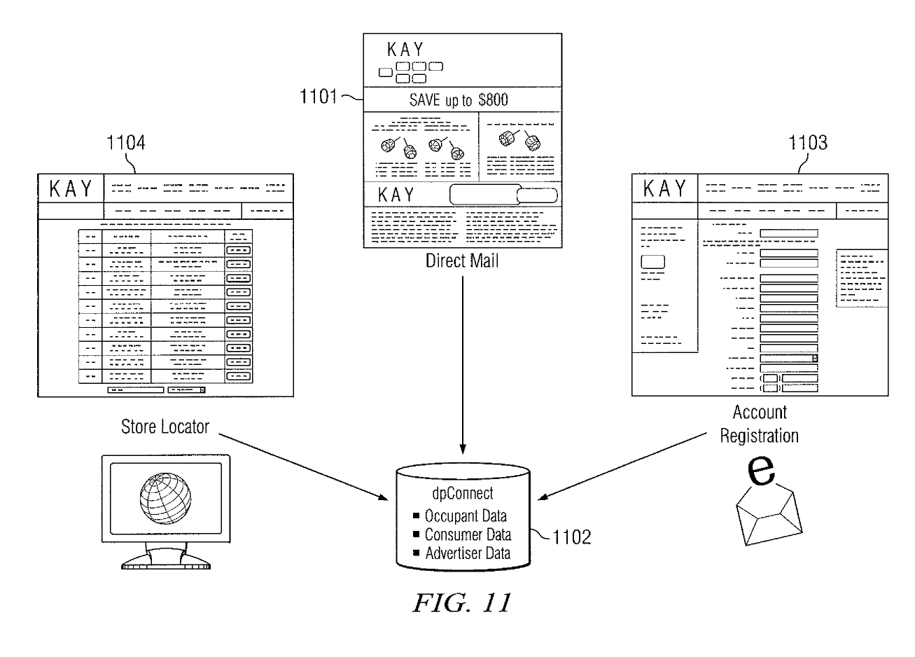

As shown in FIG. 11, various applications are shown for the use of a DP-URL code for a particular unique address to provide information to the DP-URL Response database 1102. This information provided to the DP-URL Response database 1102 may include occupant data, consumer data and advertiser data. This data is can be provided to the DP-URL Response database 1102 through webpage response pages and account registrations 1103, accessing the DP-URL address provided on direct mailings 1101, and accessing store locator pages and requesting directions on store locator page 1104. Other ways to access the DP-URL Response database 1102 and provide information to that database include call centers, point of sale terminals, and website access.

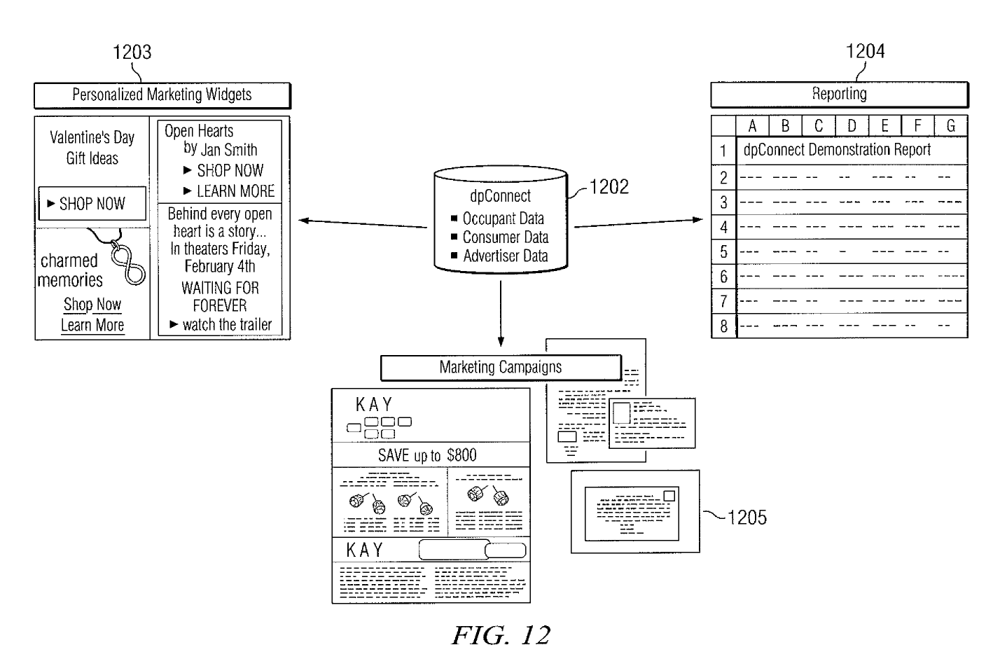

As shown in FIG. 12, the information provided to the DP-URL Response database 1202 may include occupant data, consumer data and advertiser data. This data is then used to produce specific reports to advertisers or product producers 1204, prepare specific types of marketing materials through particular types of marketing channels 1205 (e.g. emails, letters, postcards), and prepare personalized “landing pages” 1203 that provide the user or recipient with particular banner or side page advertisements based on the particular preferences recorded about the user or recipient on the DP-URL Response database 1202. Particular types of products or specific redeemable offers may be placed on the landing page 1203 for a particular household, user or recipient based on personalized preferences recorded in the DP-URL Response database 1202 for that household, user or recipient associated with that DP-URL code.

FIG. 13 shows a direct mailing 1302 with DP-URL code 1301 associated with a particular unique location or address. A user, recipient, or consumer may receive a direct mailing 1302 that possesses a delivery point user uniform resource locator DP-URL designation 1301 that is unique to the recipients' address location, such as “www.valpakinfo.com/75050-1234-02” or “www.customerurl.com/75050-1234-02.” The first part of this DP-URL code identifier is the uniform resource locator URL number, and the second part of the DP-URL code after the “/” mark is the delivery point identifier that is unique to a particular household or location in a region or country. The DP-URL code may be generated based on database information for a particular user or recipient, such as the recipient's zip code and address. This address and zip code information, as well as name and other information, may be entered by the user or recipient on the webpage (e.g. 403) or may be generated from mailing lists or other database information. From this type of information, the DP-URL code can be generated.

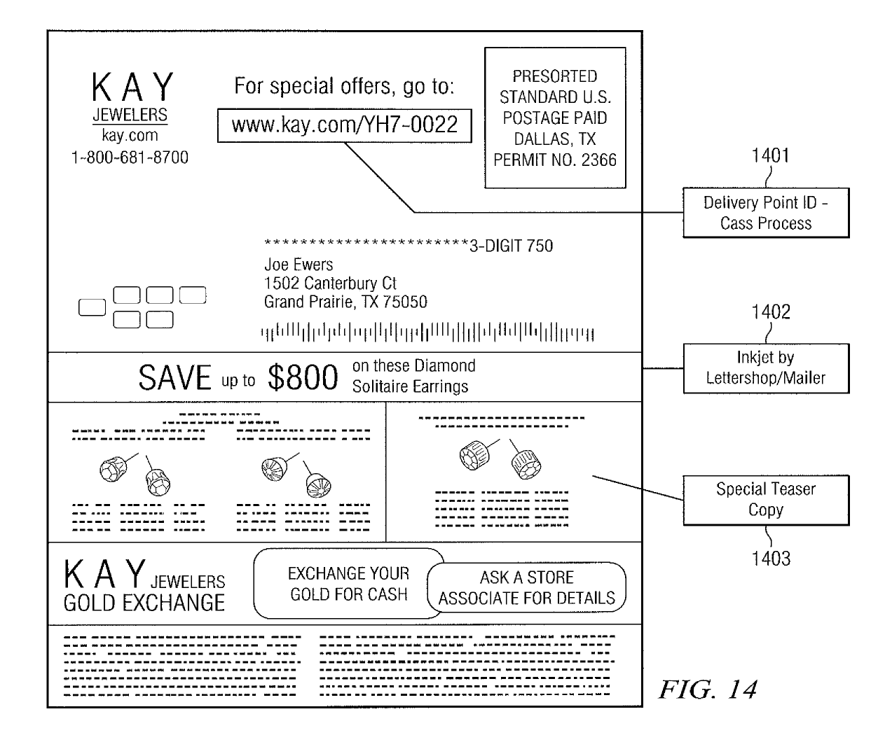

The direct mailing shown in FIG. 14 is a letter-type mailer 1402 that includes a delivery point user uniform resource locator DP-URL designation 1401 that is unique to the recipients' address location, such as “www.valpakinfo.com/75050-1234-02” or “www.customerurl.com/75050-1234-02.” The first part of this DP-URL code identifier is the uniform resource locator URL number, and the second part of the DP-URL code after the “/” mark is the delivery point identifier that is unique to a particular household or location in a region or country. The DP-URL code may be generated based on database information for a particular user or recipient, such as the recipient's zip code and address. This address and zip code information, as well as name and other information, may be entered by the user or recipient on the webpage (e.g. 403) or may be generated from mailing lists or other database information. From this type of information, the DP-URL code can be generated. Special teaser copy 1403 can also be included that emphasize a special offer or bargain price.

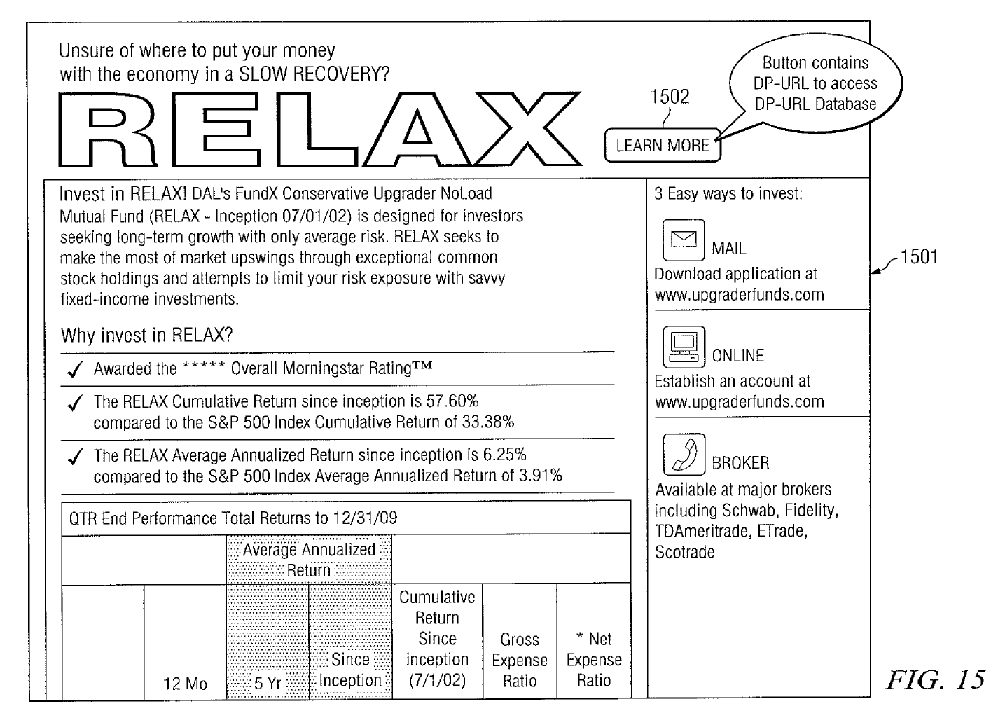

The electronic mailing 1501 shown in FIG. 15 contains a “Learn More” button 1502 that contains a delivery point user uniform resource locator DP-URL designation that is unique to the recipients' address location, such as “www.valpakinfo.com/75050-1234-02” or “www.customerurl.com/75050-1234-02.” When a user presses the “Learn More” button, the web page is automatically directed to the DP-URL applications program with the DP-URL designation. The first part of this DP-URL code identifier is the uniform resource locator URL number, and the second part of the DP-URL code after the “/” mark is the delivery point identifier that is unique to a particular household or location in a region or country. The DP-URL code may be generated based on database information for a particular user or recipient, such as the recipient's zip code and address. This address and zip code information, as well as name and other information, may be entered by the user or recipient on the webpage (e.g. 403) or may be generated from mailing lists or other database information. From this type of information, the DP-URL code can be generated.

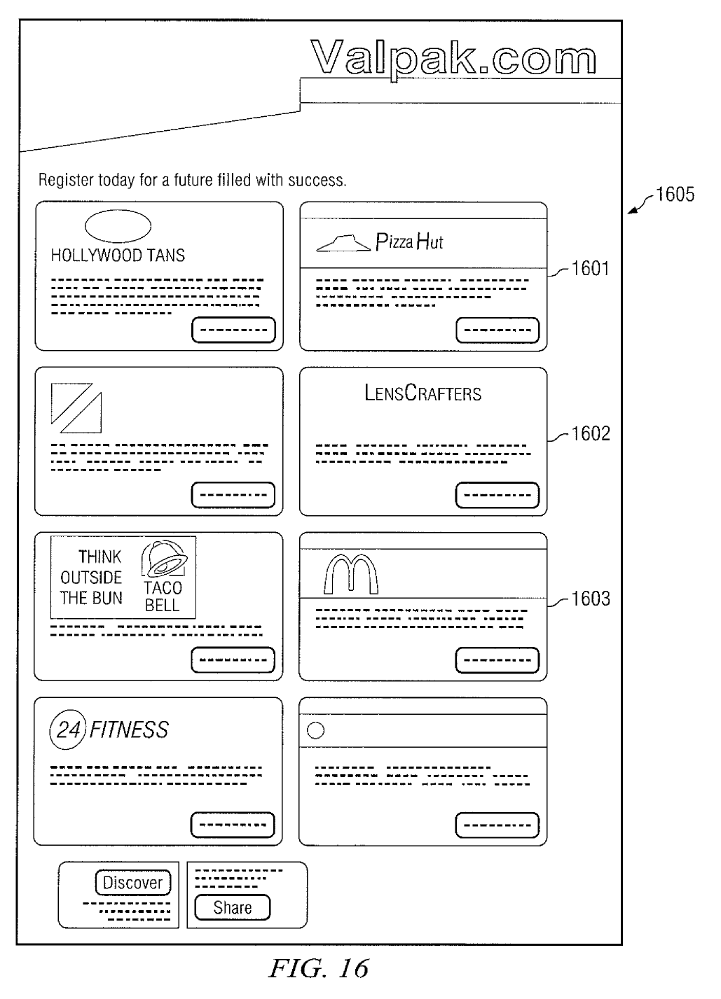

The DP-URL code can also be entered as a quick link to an email solicitation directed to the user or recipient as shown in 1502, or a user or recipient may enter the DP-URL code into a webpage identifier for the Internet. When the user or recipient enters the DP-URL code as an Internet address designation, a DP-URL applications program is accessed (e.g. step 408), where the applications program looks up the DP delivery point designator address, dynamically generates a personalize webpage 1605 based on the delivery point DP designation. One dynamic webpage is shown in FIG. 16 to provide the user or recipient with specific redeemable offers 1601, 1602, and 1603 that can be obtained with registration. The applications program may log activities of the user or recipient associated with that unique delivery point DP designation, and gather additional information from the user or recipient associated with that unique delivery DP designation upon registration by the user or recipient. This landing page 1605 may also have personalized banner or other advertising directed to the user or recipient.

As an alternative of the DP-URL 11 digit delivery code, a unique six or eight character alpha numerical code may be used to make it easy to type and enter by consumer. This shorter code length can be achieved through data compression or encryption techniques, and the DP can also be embedded into the QR-code as well. Many other alternative digit codes, compression, and encryption techniques can be used, as well as bar codes, QR codes, or other postal or graphical depictions of the DP code.

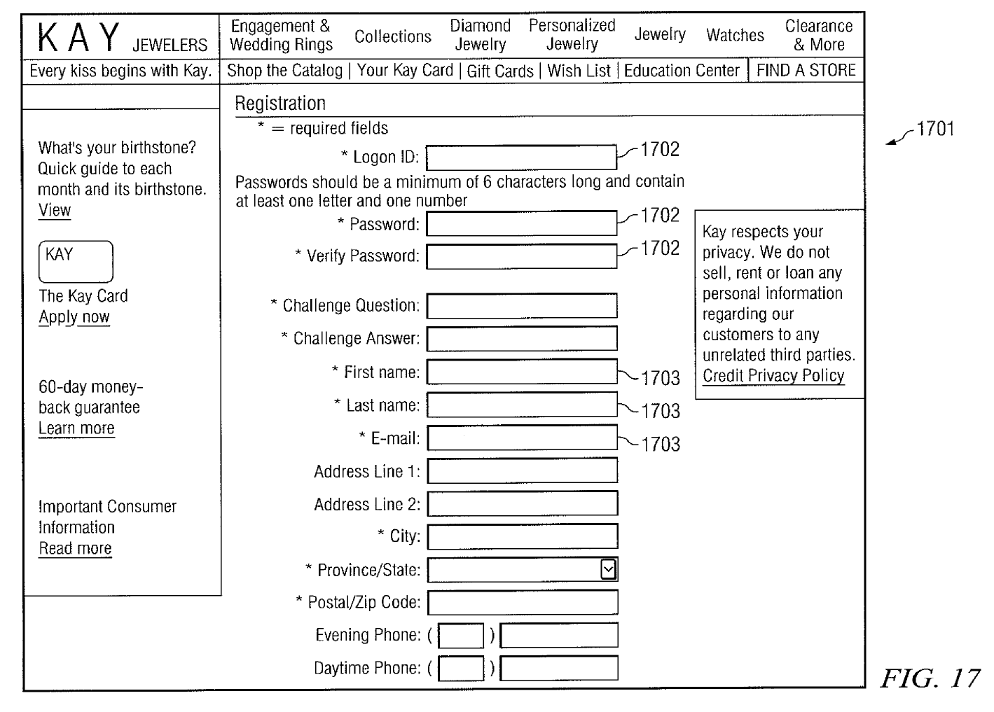

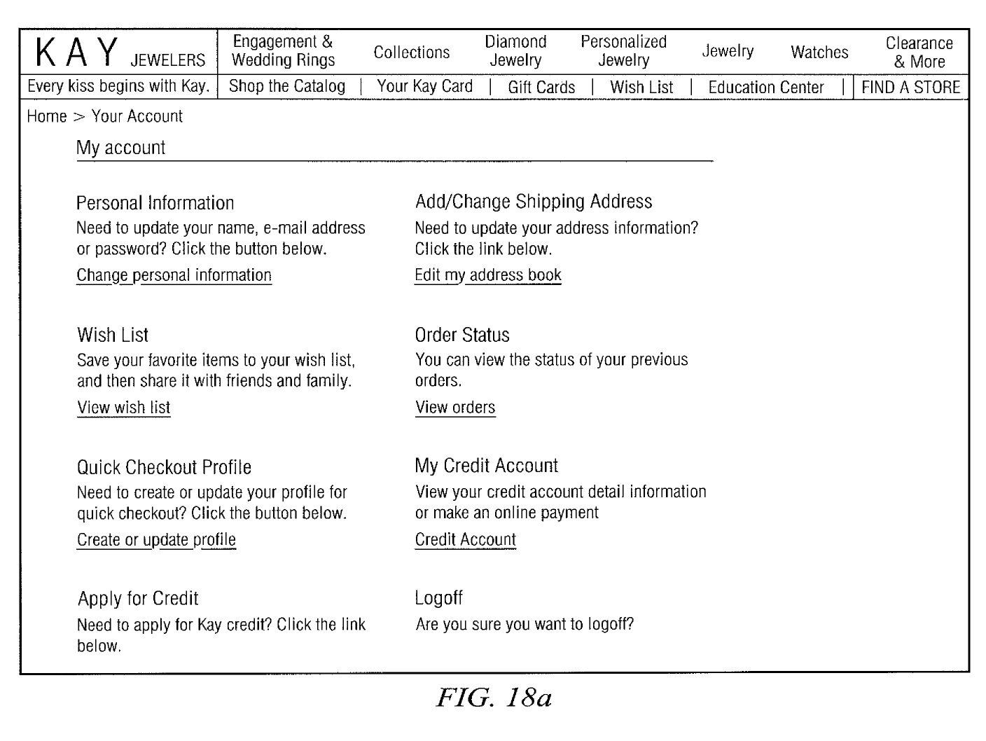

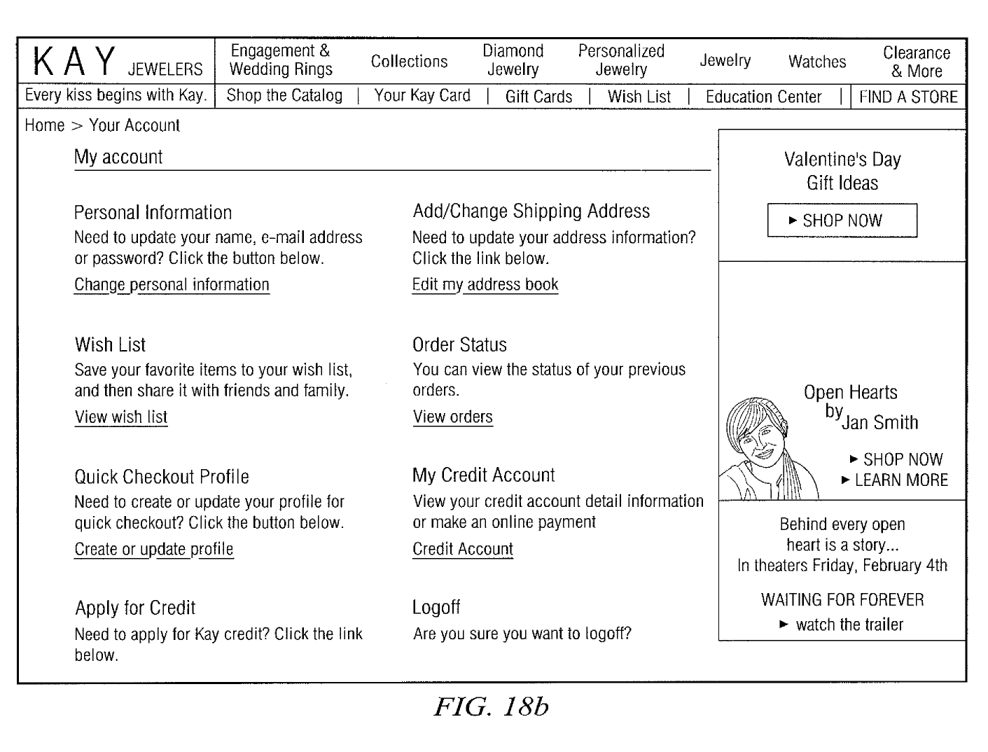

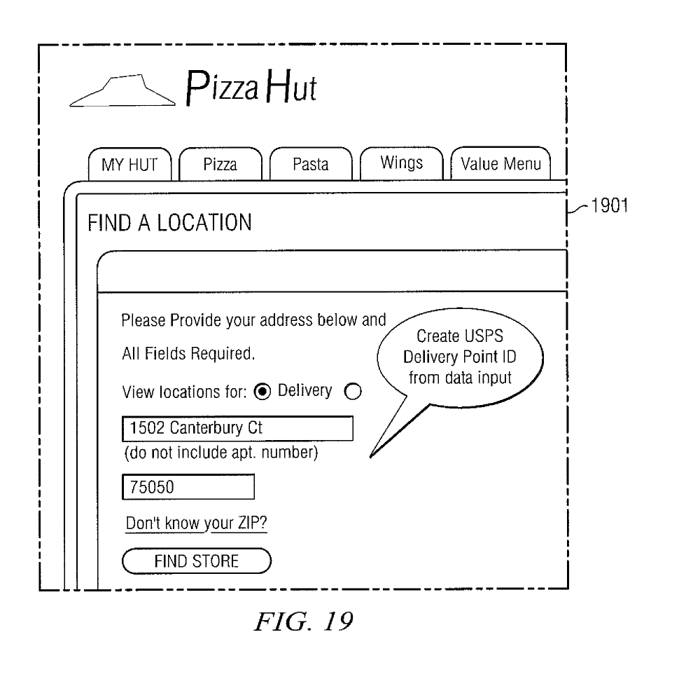

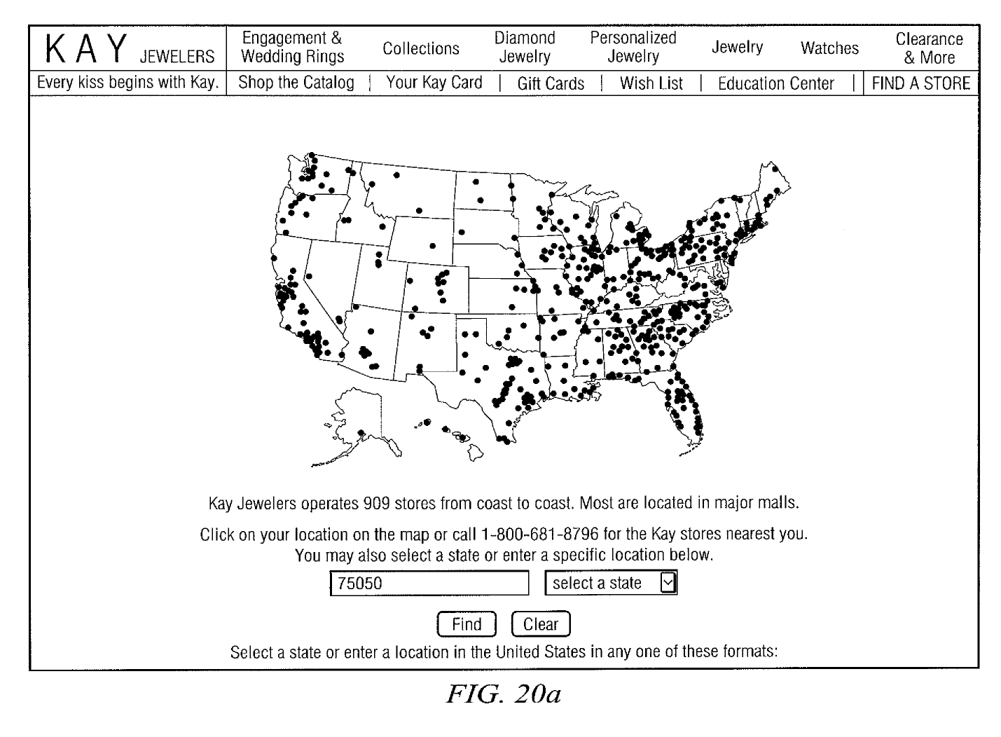

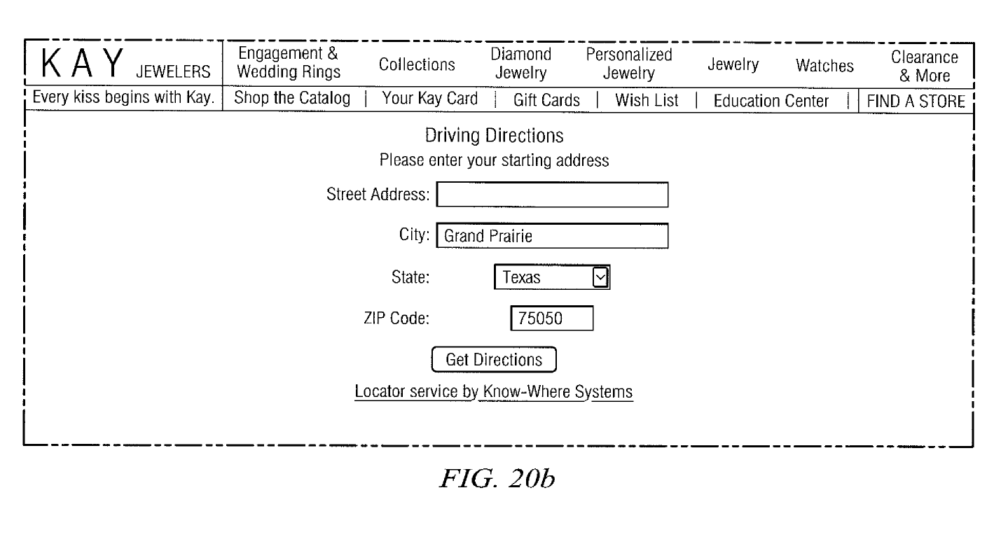

FIG. 17 shows the registration page 1701 requesting login and password information 1702 and account user address, email and phone information 1703. This registration page 1701 may also have personalized banner or other advertising directed to the user or recipient, which is shown in FIG. 18b. FIG. 18b includes personalized banner ads and other advertisements based on the personal preferences recorded for the user or recipient associated with the DP-URL information provided, which can be compared to FIG. 18a that does not include such personalized banner advertisements. FIG. 19 shows a “Find a Location” webpage 1901 on an advertiser's traditional webpage where a DP identification code is prepared and generated based on the entry of location information on the “Find a Location” website by a user or recipient. FIG. 20a provides a graphical response to the website inquiry from webpage 1901 or provides all known locations and requests more specific location information from the user or recipient. FIG. 20b provides Driving Directions in response to the street address listed. The webpages at FIGS. 19, 20a and 20b allow for a DP identification code to be prepared and generated based on the entry of location information on the “Find a Location” website by a user or recipient.

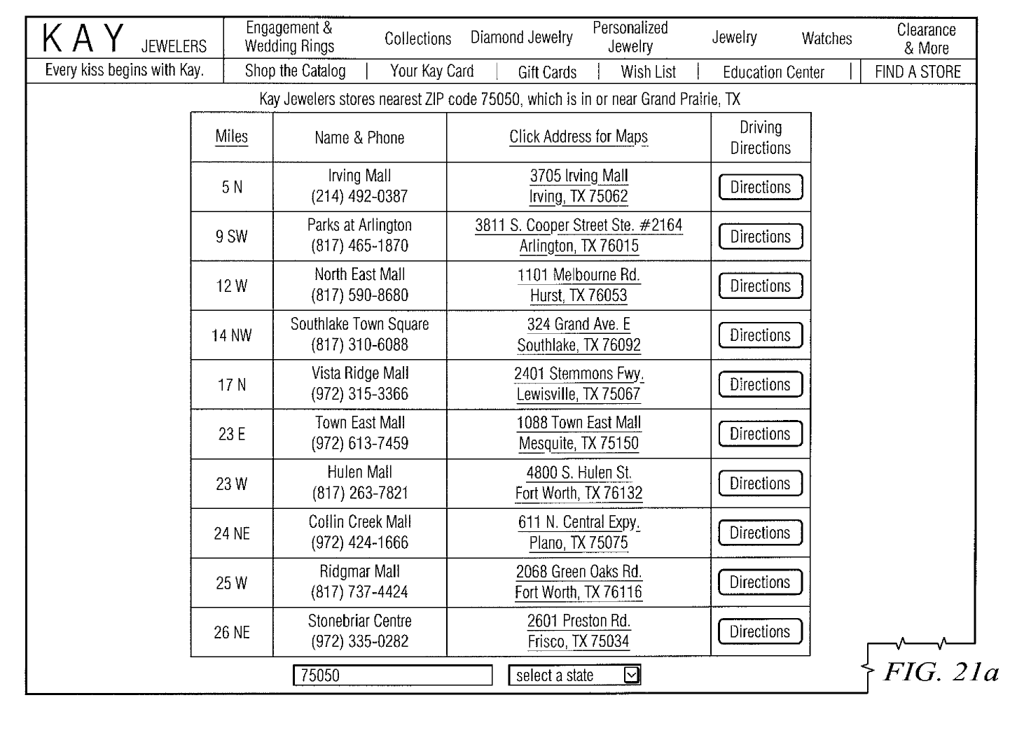

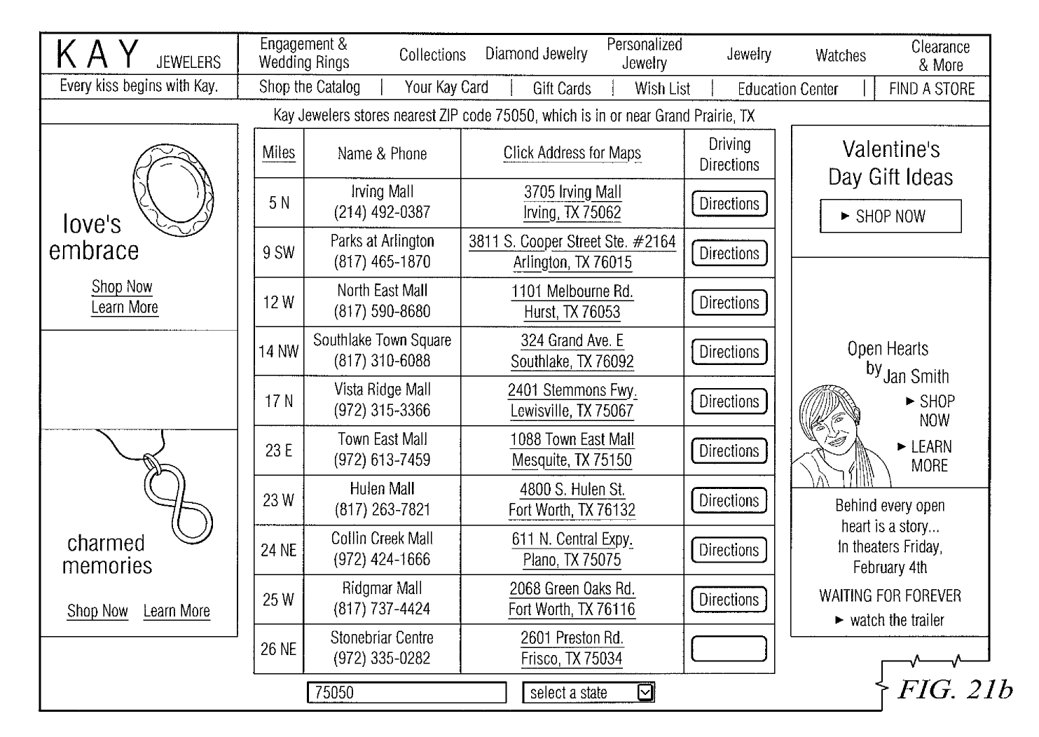

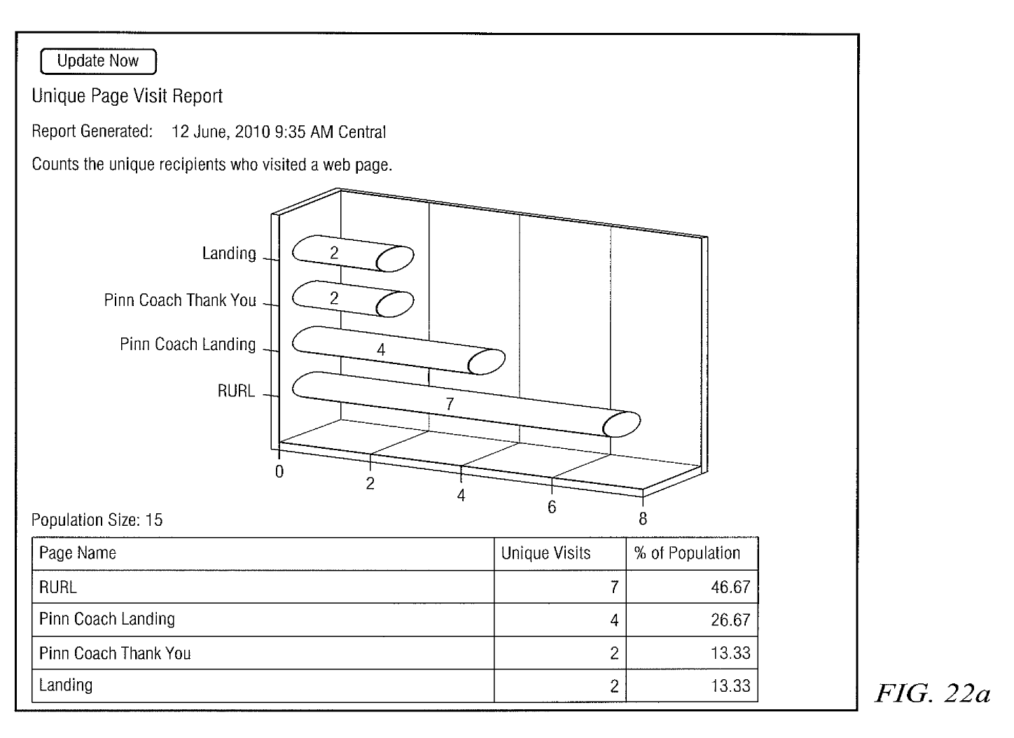

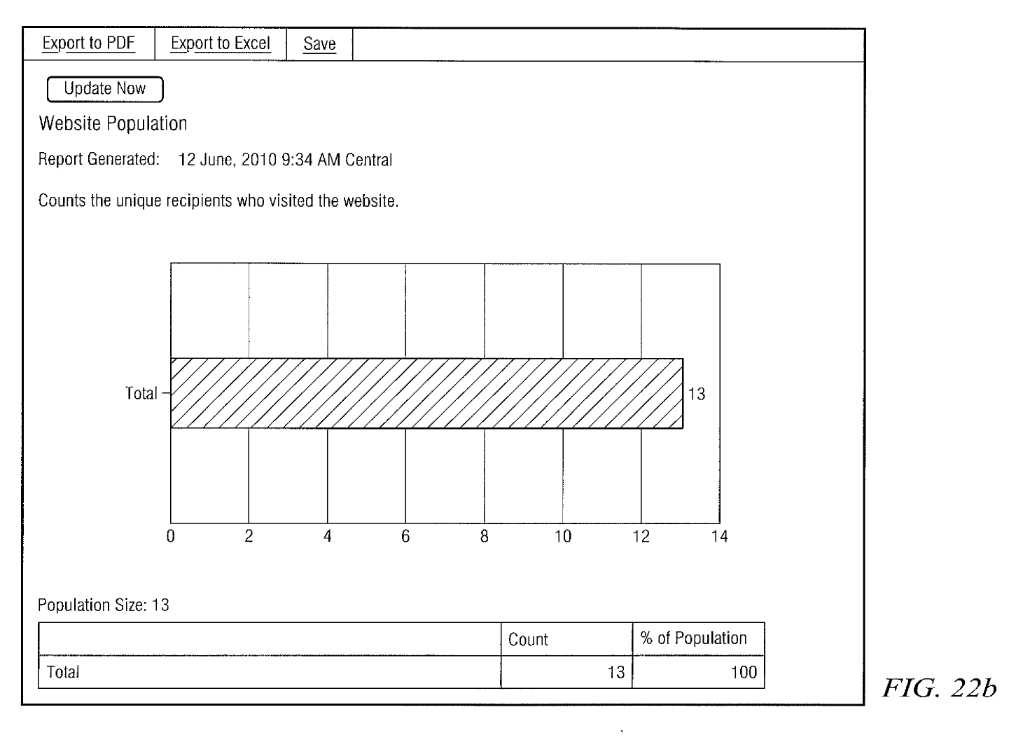

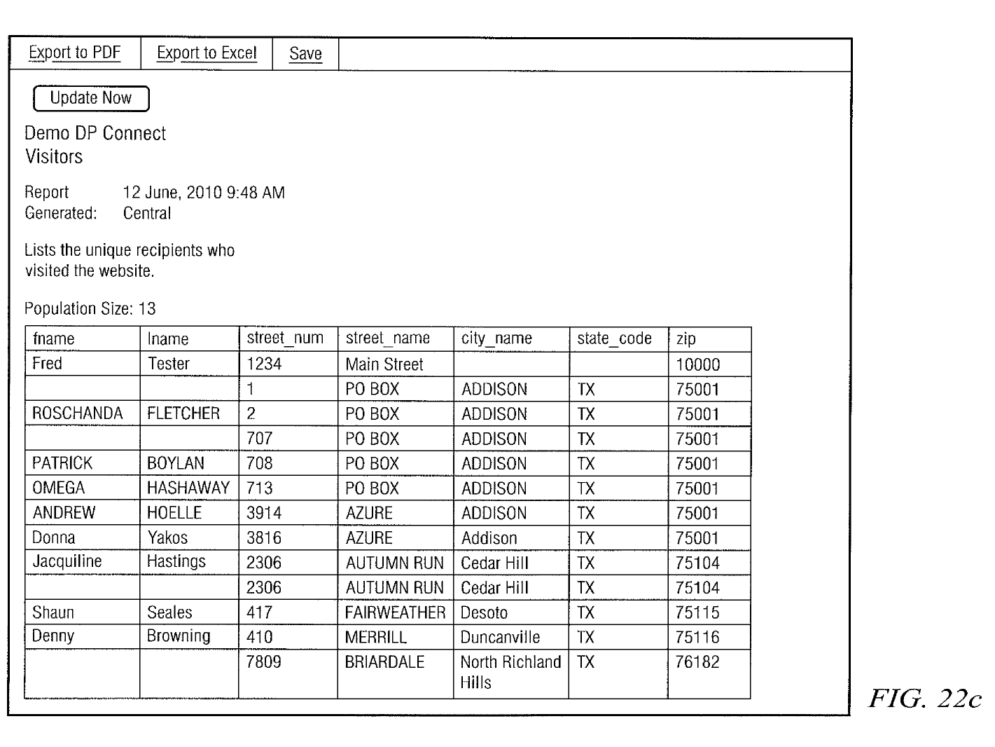

Based on the DP identification code generated, the responsive “Store Location” page shown on FIG. 21b may also have personalized banner or other advertising directed to the user or recipient. FIG. 21b includes personalized banner ads and other advertisements based on the personal preferences recorded for the user or recipient associated with the DP-URL information provided, which can be compared to FIG. 21a that does not include such personalized banner advertisements. Three types of Reports generated based on the information deposited in the DP-URL Response database 410 include those report bar graphs in FIG. 22a, population graphs in FIG. 22b, and listing information reports in FIG. 22c.

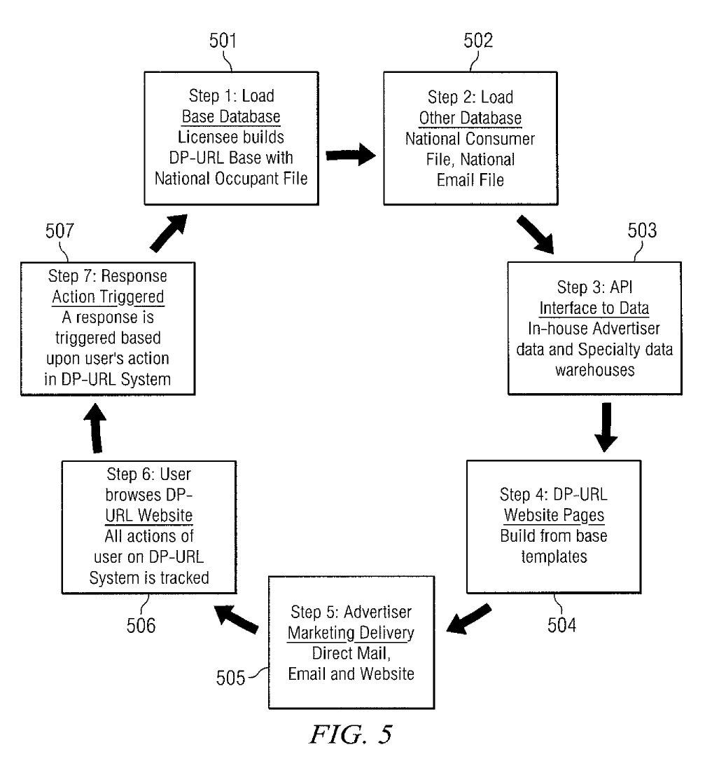

FIGS. 5 to 9 show the workflow processing that is conducted on the computer system that maintains the applications program 408. In FIG. 5, the workflow cycle is shown with the DP-URL database 410 is built by the user with National Occupant File Database in step 501, and then loads other database information into the DP-URL database 410 at step 502. In-house advertiser data and other specialty data is loaded into the DP-URL database 410 at step 503, and then the user builds DP-URL webpages from base templates at step 504.

The advertiser or promoter delivers marketing materials at step 505 by direct mailing, email or website pages, and then at step 506, the user or recipient browses the DP-URL website generated by the applications program for the user or recipient based on the DP-URL address entered into the Internet address webpage. At step 506, all actions of the user or recipient are tracked by the DP-URL system, and the system triggers a response based on the user or recipient's actions on the DP-URL system webpages at step 507, such as getting other promotional materials or direct marketing materials based on the personalized and particularized information provided by the user or recipient.

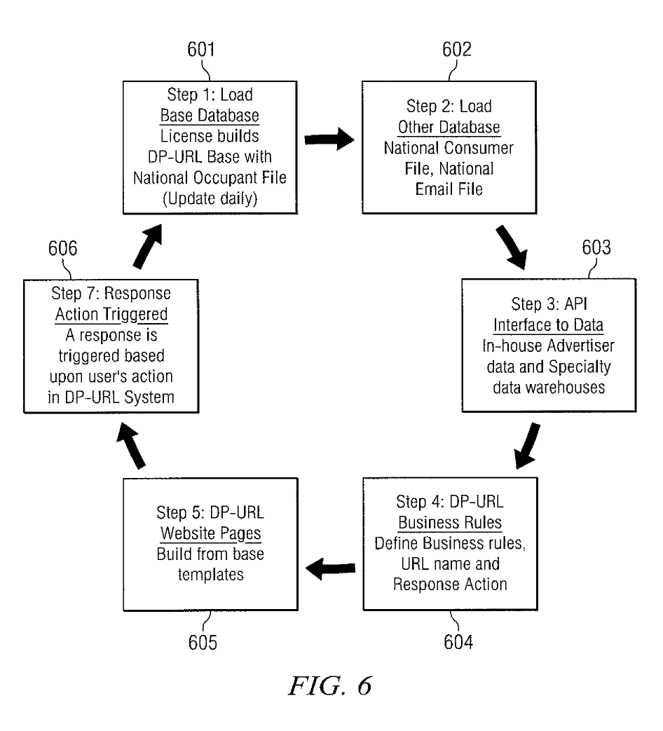

In FIG. 6, the Licensee workflow cycle is shown with the DP-URL database 410 is built by a licensee with National Occupant File Database (updated daily) in step 601, and then loads other database information (e.g. consumer files or email files) into the DP-URL database 410 at step 602. In-house advertiser data and other specialty data is loaded into the DP-URL database 410 at step 603, and then the licensee user defines business rules in step 604, which set forth the URL name and response actions provided to certain inquiries or messages.

In step 605, DP-URL webpages are built from base templates, and the system triggers a response based on the user or recipient's actions on the DP-URL system webpages at step 606, such as getting other promotional materials or direct marketing materials based on the personalized and particularized information provided by the user or recipient. The advertiser or promoter delivers marketing materials by direct mailing, email or website pages, and the user or recipient browses the DP-URL website generated by the applications program for the user or recipient based on the DP-URL address entered into the Internet address webpage.

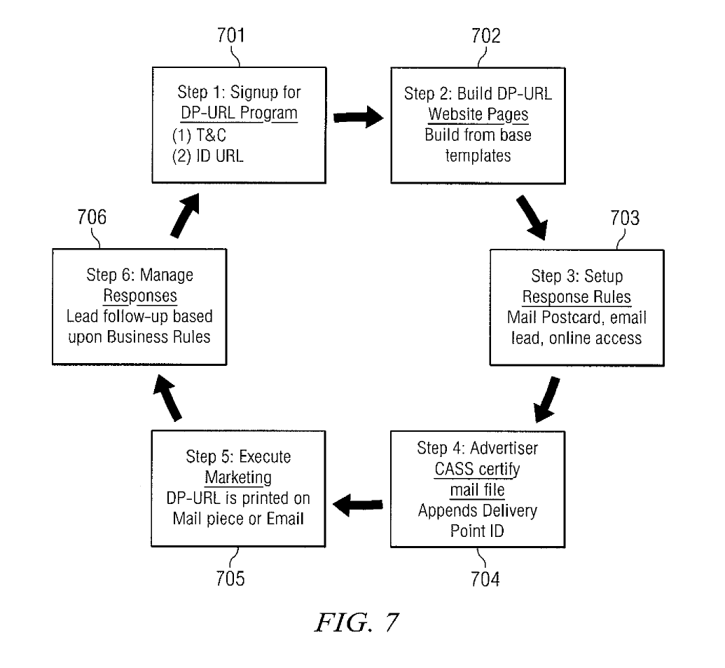

As shown in FIG. 7, the Advertiser workflow cycle is shown with the sign up for the DP-URL program at step 701, and the advertiser builds DP-URL webpages from base templates at step 702. In step 703, the advertiser sets up business rules for responses, which define responses by postcard, mailing, email or online access and responsive actions provided to certain inquiries or messages. In step 704, the advertiser certifies a mail file and appends the delivery point identification code DP to the mailing or email.

After step 704, the advertiser prints the mail piece or email with the DP URL at step 705 and sends the mailings out. In step 706, the advertiser manages the responses to leads developed from the mailings based on the rules established for responses in step 703.

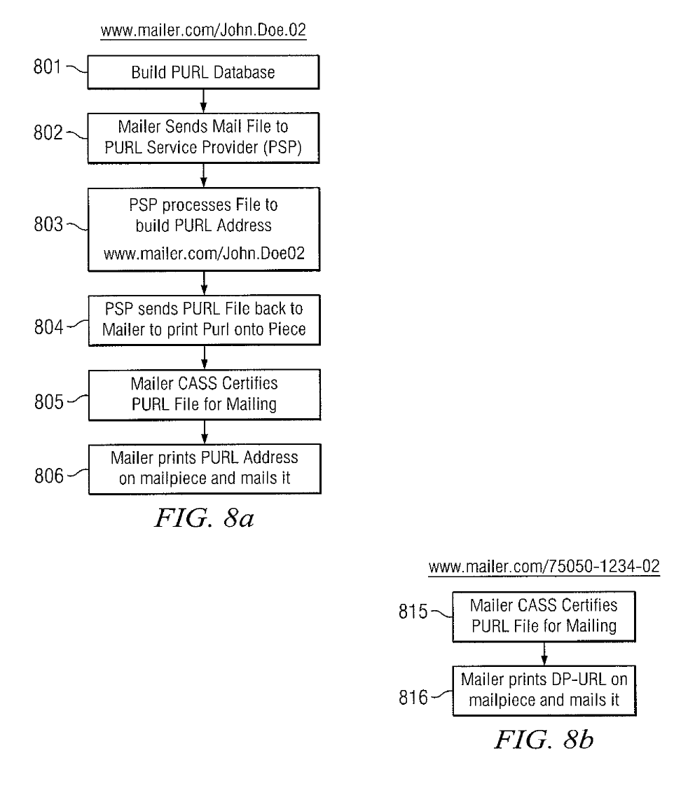

In FIG. 8a, the traditional direct mailing protocol is shown where a PURL database is built in step 801, the mailer sends the mail file database to the PURL service provider in step 802, the service provider builds the PURL addresses at step 803 and sends the PURL file back to the mailer for printing at step 804. The mailer certifies the CASS PURL mail file for mailing in step 805, and the mailer prints the PURL addresses on mail pieces and mails the pieces at step 806. Comparatively, the present invention simplifies this process tremendously. As shown in FIG. 8b, the mailer certifies the PURL file for mailing using the DP-URL addressing designation codes in step 815. The mailer then prints the DP-URL code on the mail pieces and mails them in step 816.

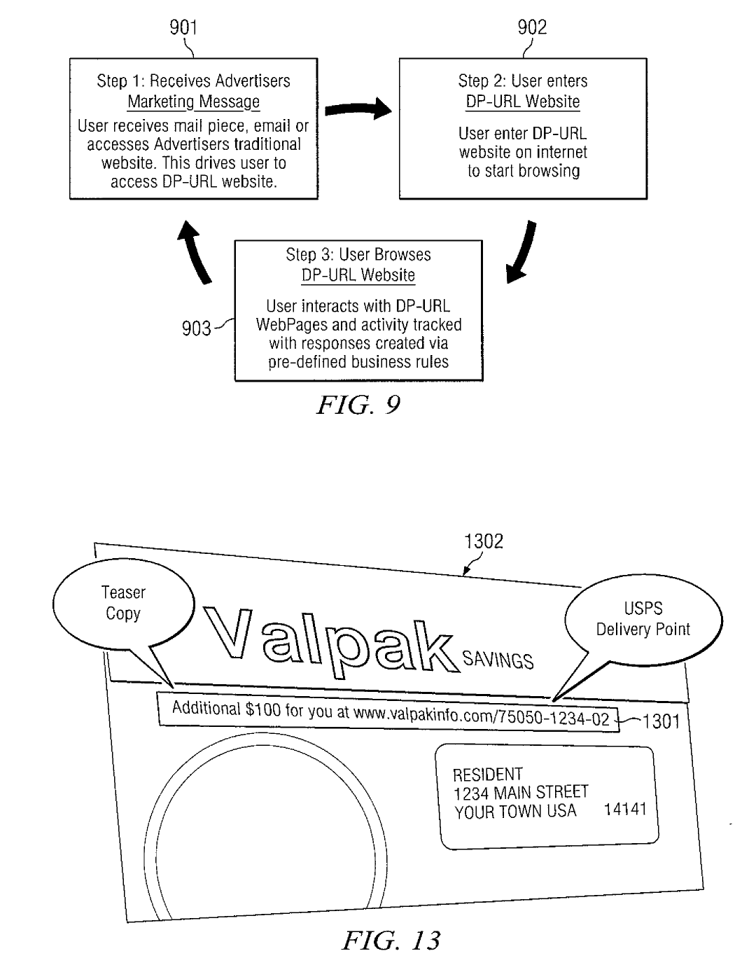

In FIG. 9, the user workflow cycle is shown with, at step 901, the user receiving the marketing materials by direct mailing, email or website pages, and then at step 506, the user or recipient browses the DP-URL website generated by the applications program for the user or recipient based on the DP-URL address entered into the Internet address webpage. The user accesses the DP-URL website with the DP-URL address in step 902, and the user interacts with the DP-URL webpage in step 903. During step 903, the user's activities and responses are tracked, and responses are provided to the user based on the business rules defined by the licensee or the advertiser.

The Tables with remarks identified below show the methods DPConnectService (Table 1), DecodeDP (Table 2), Encode DP (Table 3), GetDPConnnectData (Table 4), GetDPConnectDataByAddress (Table 5), DPConnectService (Table 6), DPConnectData (Table 7). Each Table is shown below as follows:

TABLE 1
DPConnectService

Description
DP Connect WS Methods
Methods

| Name | Description |
|---|---|
| DecodeDP | Decode a dpCode value and return |
| | the Delivery Point Code |
| EncodeDP | Encode the Delivery Point Code and return |
| | an encoded representation of the DP code |
| GetDpConnectData | Get demograhic data by Delivery Point |
| GetDpConnectDataByAddress | Get demogaphic data by Address |

TABLE 2
DecodeDP

```
Description
  Decode a dpCode value and return the Delivery Point Code
Style
  Document
Input
  dpCode to be decoded
```

| Element | Type | Description |
|---|---|---|
| dp_code | string | Devlivery point code |

Output
Devliery Point Code

| Element | Type | Description |
|---|---|---|
| DecodeDPResult | string | Response XML |

```
Remarks
  The dpCode is an alphanumeric representation of the Delivery
  Point Code that can be used to mask the acutal USPS delivery point.
  Example:
  DP: 750194683502
  dpCode: YGONK8U
  Either Deliver Point Code or dpCode can be used in the
  dpConnect system.
```

TABLE 3
Encode DP

```
Description
  Encode the Delivery Point Code and return an encoded
  representation of the DP code
Style
  Document
Input
  Delivery Point Code to encoded
```

| Element | Type | Description |
|---|---|---|
| dp_code | string | Delivery point code |

Output
dpCode

| Element | Type | Description |
|---|---|---|
| EncodeDPResult | string | Response XML |

```
Remarks
  The dpCode is an alphanumeric representation of the Delivery
  Point Code that can be used to mask the acutal USPS delivery point.
  Example:
  DP: 750194683502
  dpCode: YGONK8U
  Either Deliver Point Code or dpCode can be used in the
  dpConnect system.
```

TABLE 4
GetDPConnnectData

```
Description
  Get demographic data by Delivery Point
Style
  Document
Input
  The input of this method is the argument GetDpConnectData
  having the structure defined by the following table.
```

| Element | Type | Description |
|---|---|---|
| dp_code | string | Delivery point code |
| companyID | string | Company ID |

```
Output
  The output of this method is the argument
  GetDpConnectDataResponse
  having the structure defined by the following table.
```

| Element | Type | Description |
|---|---|---|
| GetDpConnectDataResults | DpConnectData | Response XML |

TABLE 5
GetDPConnectDataByAddress

| Description | | |
|---|---|---|
| Get demographic data by Address | | |
| Style | | |
| Document | | |
| Input | | |
| The input of this method is the argument | | |
| GetDpConnectDataByAddress having | | |
| the structure defined by the following table. | | |
| Element | Type | Description |
| address | string | Address |
| zipcode | string | Zip code |
| companyID | string | Company ID |
| Output | | |
| The output of this method is the argument | | |
| GetDpConnectDataByAddressResponse | | |
| having the structure defined by the following table. | | |
| Element | Type | Description |
| GetDpConnectData- | DpConnectData | Response XML |
| ByAddressResult | | |

TABLE 6
DPConnectService

| Description | |
|---|---|
| DP Connect Data Types | |
| Complex Types | |
| Name | Description |
| DpConnectData | DP Connect results structure |

TABLE 7
DPConnectData

```
Description
  DP Connect results structure
Content Model
  Contains elements as defined in the following table.
```

| Component | Type | Description |
|---|---|---|
| dp_age | string | Age-2 year band |
| dp_gender | string | Gender of 1st name |
| dp_marital | string | Marital status |
| dp_income | string | Income level text |
| | | Income level description: |
| | | 0 = Less than $15,000 |
| | | 1 = $15,000 − $19,999 |
| | | 2 = $20,000 − $29,999 |
| | | 3 = $30,000 − $39,999 |
| | | 4 = $40,000 − $49,999 |
| | | 5 = $50,000 − $74,999 |
| | | 6 = $75,000 − $99,999 |
| | | 7 = $100,000 − $124,999 |
| | | 8 = $125,000+ |
| | | 9 = UNKNOWN |
| dp_children | string | Children present |
| dp_length_rez | string | Length of residence |
| dp_address | string | Address |
| dp_address2 | string | Address line 2 |
| dp_city | string | City |
| dp_state | string | State |
| dp_zip | string | Zip |
| dp_firstname | string | First name |
| dp_lastname | string | Last name |
| dp_db_timespent_txt | string | Time spent on address lookup |
| dp_demo_timespent_txt | string | Text for time spent on address lookup |
| dp_total_timespent_txt | string | Total request time text |
| dp_inc_level | int | Income level |
| dp_adult_age_range | string | Adult age range |
| dp_occu1 | string | Occupation name 1 |
| dp_edu1 | string | Education of name 1 |
| dp_occu2 | string | Occupation name 2 |
| dp_edu2 | string | Education of name 2 |
| dp_child_ages | string | Child ages |
| dp_biz_owner | string | Business owner |
| dp_working_women | string | Working women |
| dp_mail_dma | string | Do not mail list |
| dp_homeowner | string | Homewoner/Renter |
| dp_mo_buyer | string | Mail order buyer |
| dp_mo_reponder | string | Mail order responder |
| dp_mo_donor | string | Mail order donor |
| dp_err_msg | string | Error message |
| dp_err | int | Error code |

Many combinations of the different architectures and system providing access and database can be used to provide a comprehensive support framework for the invention. The above-described embodiments of the present application are intended to be examples only. Those of skill in the art may effect alterations, modifications and variations to the particular embodiments without departing from the scope of the application. In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system for delivering promotions and product information to consumers, comprising:
a first computer system having an input and an output, a computer processor, a database and associated memory, the computer system generates a listing of delivery point codes that uniquely identify a location or residence in a predetermined area, said delivery point codes being appended to a resource locator code that identifies an Internet address associated with a webpage supported on a computer server,
said computer server being accessed using the resource locator code and a first particular delivery point code associated with a particular first location or residence, said computer server transmitting information in response to the receipt of the resource locator code and the first particular delivery point code, the transmitted information includes personalized promotion and product information based on preferences maintained on the database related to the recipient associated with the delivery point code.

2. The system for delivering promotions and product information to consumers in claim 1 wherein the information transmitted to the user includes a redeemable promotional offer.

3. The system for delivering promotions and product information to consumers in claim 1 wherein the information transmitted to the user includes a banner advertisement.

4. The system for delivering promotions and product information to consumers in claim 1 wherein the information transmitted to the user includes an advertisement that is personalized to a consumer preference of the recipient.

5. The system for delivering promotions and product information to consumers in claim 1 wherein the database is indexed with the unique delivery point identification codes that are associated with addresses for each household in a region or country.

6. The system for delivering promotions and product information to consumers in claim 1 wherein the delivery point identification code is used when accessing a website on the Internet.

7. The system for delivering promotions and product information to consumers in claim 1 wherein the personal preferences are recorded in the database based on responses provided by the recipient associated with the delivery point code.

8. The system for delivering promotions and product information to consumers in claim 1 wherein the personal preferences are recorded in the database based on the Internet activities previously conducted by the recipient associated with the delivery point code.

9. The system for delivering promotions and product information to consumers in claim 1 wherein reports are provided at the output of the computer system describing consumer activities and preferences.

10. A system for delivering promotions and product information to consumers, comprising:
a first computer system having an input and an output, a computer processor, a database and associated memory, the computer system generates a listing of delivery point codes that uniquely identify a location or residence in a predetermined area, said delivery point codes being appended to a resource locator code that identifies an Internet address associated with a webpage supported on a computer server,
said computer server being accessed using the resource locator code and a first delivery point code associated with a particular first location or residence, said computer server transmitting a personalized webpage in response to receipt of the resource locator code and the first delivery point code, the personalized webpage includes personalized promotion and product information maintained on the database related to the recipient associated with the delivery point code.

11. The system for delivering promotions and product information to consumers in claim 8 wherein the information transmitted to the user also includes a redeemable promotional offer.

12. The system for delivering promotions and product information to consumers in claim 8 wherein the information transmitted to the user also includes a banner advertisement.

13. The system for delivering promotions and product information to consumers in claim 8 wherein the information transmitted to the user also includes an advertisement that is personalized to a consumer preference of the recipient.

14. The system for delivering promotions and product information to consumers in claim 8 wherein the database is indexed with the unique delivery point identification codes that are associated with addresses for each household in a region or country.

15. The system for delivering promotions and product information to consumers in claim 8 wherein the delivery point identification code is used when accessing a website on the Internet.

16. The system for delivering promotions and product information to consumers in claim 10 wherein the personal preferences are recorded in the database based on responses provided by the recipient associated with the delivery point code.

17. The system for delivering promotions and product information to consumers in claim 10 wherein the personal preferences are recorded in the database based on the Internet activities previously conducted by the recipient associated with the delivery point code.

18. The system for delivering promotions and product information to consumers in claim 10 wherein reports are provided at the output of the computer system describing consumer activities and preferences.

19. A method for delivering promotions and product information to consumers, comprising:
providing a first computer system having an input and an output, a computer processor, a coupled database, and associated memory,
generating at the computer system a listing of delivery point codes that uniquely identify a location or residence in a predetermined area, said delivery point codes being appended to a resource locator code that identifies an Internet address associated with a webpage supported on a computer server,
accessing the computer server using the resource locator code and a first delivery point code,
transmitting promotion and product information from the computer server in response to receipt of the resource locator code and the first delivery point code, the promotion and product information includes personalized information based on preferences maintained on the database related to the recipient associated with the delivery point code.

20. The method for delivering promotions and product information to consumers in claim 19 wherein the information transmitted to the user includes a redeemable promotional offer.

21. The method for delivering promotions and product information to consumers in claim 19 wherein the information transmitted to the user includes a banner advertisement.

22. The method for delivering promotions and product information to consumers in claim 19 wherein the information transmitted to the user includes an advertisement that is personalized to a consumer preference of the recipient.

23. The method for delivering promotions and product information to consumers in claim 19 wherein the database is indexed with the unique delivery point identification codes that are associated with addresses for each household in a region or country.

24. The method for delivering promotions and product information to consumers in claim 19 wherein the delivery point identification code is used when accessing a website on the Internet.

25. The method for delivering promotions and product information to consumers in claim 19 wherein the personal preferences are recorded in the database based on responses provided by the recipient associated with the delivery point code.

26. The method for delivering promotions and product information to consumers in claim 19 wherein the personal preferences are recorded in the database based on the Internet activities previously conducted by the recipient associated with the delivery point code.

27. The method for delivering promotions and product information to consumers in claim 19 wherein reports are provided at the output of the computer system describing consumer activities and preferences.
